(19) United States
(12) Patent Application Publication
(10) Pub. No.: US 2007/0056565 A1
(43) Pub. Date: Mar. 15, 2007

(54) Control apparatus and control method for internal combustion engine

(76) Inventors: Naohide Fuwa, Nishikamo-gun (JP); Yasunori Matsuo, Toyota-shi (JP)

Correspondence Address: KENYON & KENYON LLP, 1500 K STREET N.W., SUITE 700, WASHINGTON, DC, 20005, US

(21) Appl. No.: 11/508,184

(22) Filed: Aug. 23, 2006

(30) Foreign Application Priority Data
Sep. 9, 2005 (JP) 2005-261894

(51) Int. Cl. F01L 1/34; G01L 3/26

(52) U.S. Cl. 123/481; 123/90.15; 73/117.3

(57) ABSTRACT

A control apparatus for an internal combustion engine includes a controller. The controller determines whether a misfire occurs in any of the plurality of cylinders. If it is determined that a misfire occurs, the controller determines whether an intake valve is unable to open due to the malfunction of a valve lift mechanism. If it is determined that the intake valve is unable to open, the controller stops operation of the fuel injection valve corresponding to a cylinder of the plurality of cylinders, in which the misfire occurs, to stop a fuel supply to the cylinder from a next intake stroke until the malfunction of the valve lift mechanism is corrected, regardless of whether the internal combustion engine stops.

The disclosure of Japanese Patent Application No. 2005-261894 filed on Sep. 9, 2005, including the specification, drawings and abstract is incorporated herein by reference in its entirety.

### BACKGROUND OF THE INVENTION

1. Field of the Invention

The invention relates to a control apparatus and a control method for an internal combustion engine that includes a variable valve mechanism, which changes the operational characteristic of an intake valve using a valve lift mechanism provided between a cam and the intake valve, and a fuel injection valve, which injects fuel into each cylinder individually. More specifically, the invention relates to a technology relating to a misfire.

2. Description of the Related Art

Japanese Patent Application Publication No. JP-A-2001-263015 (hereinafter, referred to as “No. 2001-263015) describes an example of an internal combustion engine for a vehicle, which includes a variable valve mechanism that changes the operational characteristic (for example, the lift and duration) of an intake valve or an exhaust valve according to the operating state of the engine.

The variable valve mechanism includes a rocker shaft, a control shaft, and a valve lift mechanism. The rocker shaft is fixed to a cylinder head such that the rocker shaft is disposed in parallel with a cam. The control shaft is provided inside the rocker shaft. The valve lift mechanism, provided on the rocker shaft, changes the maximum lift of the intake valve or the exhaust valve.

The valve lift mechanism includes a slider gear, an input portion, and an oscillation cam. The slider gear is provided around the rocker shaft such that the slider gear can move with respect to the rocker shaft in the axial direction and in the circumferential direction. The slider gear can move in conjunction with the control shaft. The input portion, provided around the slider gear, is driven by the cam. The oscillation cam is provided around the slider gear to be adjacent to the input portion. The oscillation cam lifts the valve.

In the slider gear, an input-side helical spline that engages with the input portion, and an output-side helical spline that engages with the oscillation cam are formed. Forks (for example, refer to forks 41cR and 41cL in FIG. 5 showing an embodiment of the invention) are provided on the outer surface of the input portion at predetermined positions. The forks rotatably support a roller that contacts the outer surface of the cam.

When an actuator moves the control shaft in the axial direction, the slider gear moves with respect to the input portion in the circumferential direction, while moving in the axial direction along with the control shaft. Accordingly, the oscillation cam moves with respect to the input portion in the circumferential direction. This adjusts the maximum lift of the valve, which is lifted by the oscillation cam.

The valve lift mechanism is designed such that sufficient strength and sufficient load bearing are ensured at each component of the valve lift mechanism. However, if the forks were to break, the input portion is not moved by rotating the cam. Therefore, the valve cannot open nor close.

In the case where the variable valve mechanism is used for the intake valve, if the intake valve is kept closed and is unable to open, fuel supplied from the fuel injection valve may accumulate in the intake port, and the fuel-air mixture may not be supplied to the combustion chamber during the intake stroke. In this case, the fuel-air mixture cannot be ignited nor burned in the combustion chamber during the combustion stroke, which causes a misfire.

Accordingly, some fail-safe action needs to be taken to deal with such a situation.

Generally, in the internal combustion engine that does not include the aforementioned variable valve mechanism, a misfire may occur due to a temporary condition, such as clogging of the fuel injection valve, smoldering of the ignition plug, or failure in compression of air-fuel mixture in the combustion chamber. Accordingly, Japanese Patent Application Publication No. JP-A-5-18311 (hereinafter, referred to as “No. 5-18311”) describes a technology in which the misfire due to such a problem is detected by detecting a change in the rotational speed of the internal combustion engine.

Also, Japanese Patent Application Publication No. JP-A-2001-20792 (hereinafter, referred to as “No. 2001-20792) describes a technology in which, each time a misfire is detected in the internal combustion engine that does not include the aforementioned variable valve, fuel injection to the cylinder in which the misfire occurs is stopped.

In most cases, a misfire occurs due to the temporary condition, such as clogging of the fuel injection valve, smoldering of the ignition plug, or failure in compression of air-fuel mixture in the combustion chamber. Accordingly, in the conventional examples described in No. 5-18311 and No. 2001-20792, it is determined whether a misfire occurs during each combustion stroke; if it is determined that the misfire occurs, fuel injection is stopped until the misfire is corrected; and if it is determined that no misfire occurs, normal fuel injection is restarted during a next intake stroke.

However, in the internal combustion engine that includes the variable valve mechanism as in No. 2001-263015, if a misfire occurs due to a problem that is difficult to solve, such as the malfunction of the valve lift mechanism, even the aforementioned actions taken in No. 5-18311 and No. 2001-20792 are not effective for the following reason.

If the intake valve is kept closed and is unable to open due to the malfunction of the valve lift mechanism, the intake valve would still be unable to open during the next intake stroke. Therefore, if the misfire cannot be detected during the combustion stroke for some reason, normal fuel injection control is restarted during the next intake stroke. In a port-injection engine, because fuel is repeatedly injected to the intake port, fuel accumulates in the intake port. In a direct-injection engine, because the supply of air into the combustion chamber is interrupted, the misfire continues to occur, and unburned fuel is discharged to an exhaust port from the combustion chamber. Therefore, the aforementioned technology needs to be improved.

### SUMMARY OF THE INVENTION

In view of the above, the invention provides a control apparatus that prevents the accumulation of fuel in the intake port of a port-injection engine, or the discharge of unburned fuel to an exhaust port from a combustion chamber in a direct-injection engine, if a misfire occurs because an intake valve cannot be opened due to the malfunction of a valve lift mechanism used in a variable valve mechanism in an internal combustion engine.

An aspect of the invention relates to a control apparatus for an internal combustion engine that includes a variable valve mechanism and a fuel injection valve. The variable valve mechanism changes the operational characteristic of an intake valve using a valve lift mechanism disposed between a cam and the intake valve. The fuel injection valve supplies fuel to each of a plurality of cylinders individually. The control apparatus includes a controller. The controller determines whether a misfire occurs in any of the plurality of cylinders. If the controller determines that a misfire occurs, the controller determines whether the intake valve is unable to open due to the malfunction of the valve lift mechanism. If the controller determines that the intake valve is unable to open, the controller stops operation of the fuel injection valve corresponding to a cylinder of the plurality of cylinders, in which the misfire occurs, to stop a fuel supply to the cylinder from a next intake stroke until the malfunction of the valve lift mechanism is corrected, regardless of whether the internal combustion engine stops.

Another aspect of the invention relates to a control method for an internal combustion engine which includes a variable valve mechanism and a fuel injection valve. The variable valve mechanism changes the operational characteristic of an intake valve using a valve lift mechanism disposed between a cam and the intake valve. The fuel injection valve supplies fuel to each of a plurality of cylinders individually. The method includes determining whether a misfire occurs in any of the plurality of cylinders; determining whether the intake valve is unable to open due to the malfunction of the valve lift mechanism if it is determined that the misfire occurs; and stopping operation of the fuel injection valve corresponding to a cylinder of the plurality of cylinders, in which the misfire occurs, to stop a fuel supply to the cylinder from a next intake stroke until the malfunction of the valve lift mechanism is corrected, regardless of whether the internal combustion engine stops, if it is determined that the intake valve is unable to open.

With the configuration, if a misfire occurs because the intake valve is kept closed and is unable to open due to the malfunction of the valve lift mechanism used in the variable valve mechanism, the fuel supply continues to be stopped until the misfire is corrected by replacing or repairing the valve lift mechanism.

Thus, because fuel is not injected while the valve lift mechanism has the malfunction, it is possible to prevent occurrence of a secondary problem, such as the accumulation of fuel in the intake port of a port-injection engine, or the discharge of unburned fuel to the exhaust port from the combustion chamber in a direct-injection engine.

Another aspect of the invention relates to a control apparatus for an internal combustion engine which includes a variable valve mechanism and a fuel injection valve. The variable valve mechanism changes the operational characteristic of an intake valve using a valve lift mechanism disposed between a cam and the intake valve. The fuel injection valve supplies fuel to each of a plurality of cylinders individually. The control apparatus includes a controller. The controller determines whether a misfire occurs in any of the plurality of cylinders. If the controller determines that a misfire occurs, the controller stops operation of the fuel injection valve corresponding to a cylinder of the plurality of cylinders, in which the misfire occurs, to stop a fuel supply to the cylinder from a next intake stroke until the internal combustion engine stops.

Another aspect of the invention relates to a control method for an internal combustion engine which includes a variable valve mechanism and a fuel injection valve. The variable valve mechanism changes the operational characteristic of an intake valve using a valve lift mechanism disposed between a cam and the intake valve. The fuel injection valve supplies fuel to each of a plurality of cylinders individually. The control method includes determining whether a misfire occurs in any of the plurality of cylinders; and stopping operation of the fuel injection valve corresponding to a cylinder of the plurality of cylinders, in which the misfire occurs, to stop a fuel supply to the cylinder from a next intake stroke until the internal combustion engine stops.

With this configuration, after a misfire is detected, the fuel supply is stopped until the internal combustion engine stops, regardless of the cause of the misfire, and regardless of whether the misfire is corrected. In other words, when the internal combustion engine stops, the fuel supply is restarted, and it is determined whether a misfire occurs in a next trip. The term “trip” signifies the period from start of the engine to stop of the engine. Thus, if no misfire is detected in the trip, normal fuel injection control can be restarted.

However, if a misfire occurs due to the problem that is difficult to solve, such as the malfunction of the valve lift mechanism, and the misfire cannot be corrected until the valve lift mechanism is replaced or repaired, the fuel supply is stopped after the misfire is detected, and further, it is determined whether a misfire still occurs in the next trip. If the misfire is detected in the next trip, the fuel supply continues to be stopped. Thus, the control apparatus and the control method are advantageous in preventing occurrence of a secondary problem, such as the accumulation of a great amount of fuel in the intake port in a port-injection engine, or the discharge of unburned fuel to the exhaust port from the combustion chamber in a direct-injection engine.

### BRIEF DESCRIPTION OF THE DRAWINGS

The features, advantages thereof, and technical and industrial significance of this invention will be better understood by reading the following detailed description of the example embodiments of the invention, when considered in connection with the accompanying drawings, in which:

FIG. 1 is a schematic diagram showing the configuration of an engine to which a control apparatus according to the invention is applied;

FIG. 2 is a block diagram showing the configuration of the control apparatus in FIG. 1;

FIG. 3 is a plan view schematically showing a variable valve mechanism for an intake valve of the engine in FIG. 1;

FIG. 4 is a sectional view taken along line (4)-(4) in FIG. 3;

FIG. 5 is a perspective view showing the variable valve mechanism in FIG. 3;

FIG. 6 is an exploded perspective view of a valve lift mechanism;

FIG. 7 is an exploded perspective view showing the relation between a slider gear and a rocker shaft of the valve lift mechanism in FIG. 5;

FIG. 8 is a perspective view showing the upper half of the valve lift mechanism in FIG. 5;

FIG. 9A is a lateral view used to explain the operation of the variable valve mechanism in FIG. 3 when the phase difference between an input arm and an output arm is greatest, and the intake valve is closed;

FIG. 9B is a lateral view used to explain the operation of the variable valve mechanism in FIG. 3 when the phase difference between the input arm and the output arm is greatest, and the intake valve is open;

FIG. 10A is a lateral view used to explain the operation of the variable valve mechanism in FIG. 3 when the phase difference between the input arm and the output arm is smallest, and the intake valve is closed;

FIG. 10B is a lateral view used to explain the operation of the variable valve mechanism in FIG. 3 when the phase difference between the input arm and the output arm is smallest, and the intake valve is open;

FIG. 11 is a flowchart of a misfire control executed by the control apparatus in FIG. 1;

FIG. 12 is a timing chart relating to the misfire control that is executed when a temporary misfire occurs;

FIG. 13 is a timing chart relating to the misfire control that is executed when a misfire occurs due to the malfunction of the valve lift mechanism; and

FIGS. 14A and 14B are flowcharts of another misfire control executed by the control apparatus according to the invention.

### DETAILED DESCRIPTION OF THE EXAMPLE EMBODIMENTS

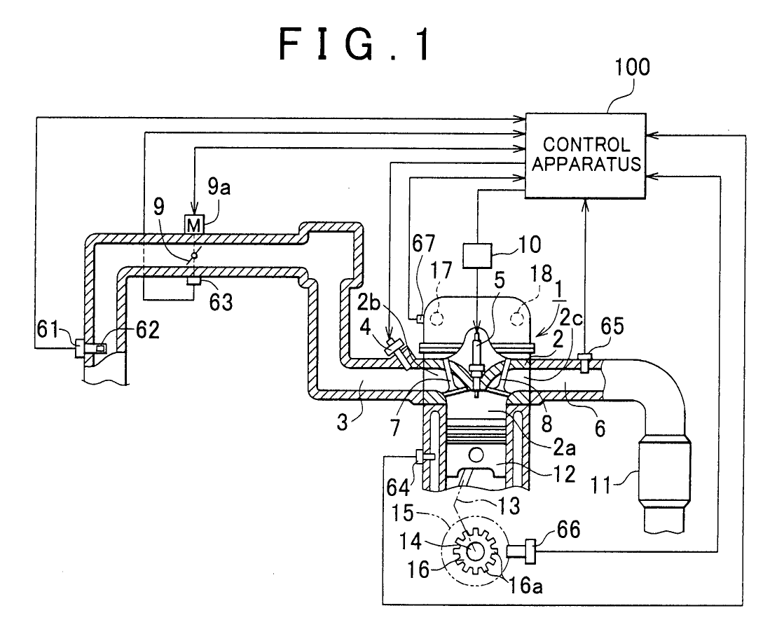

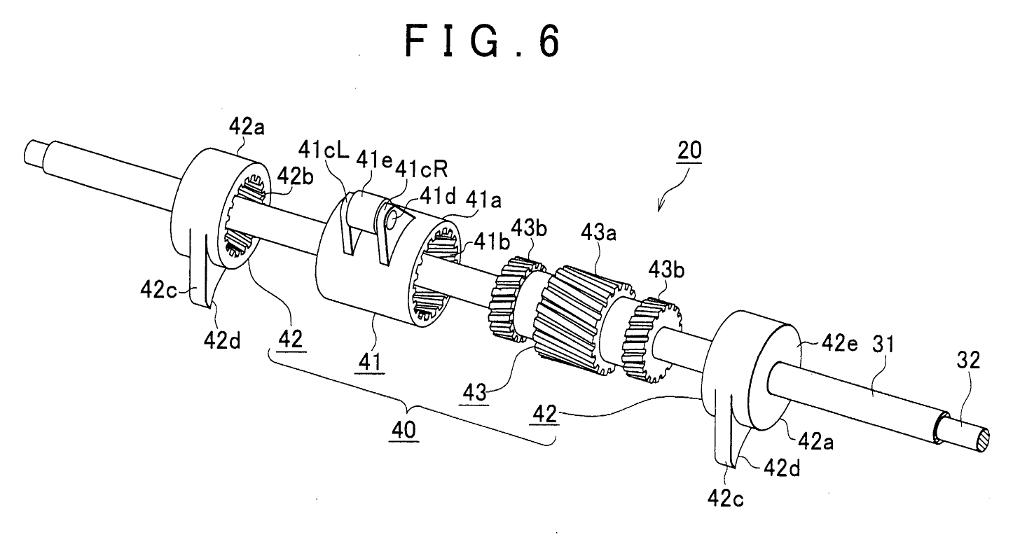

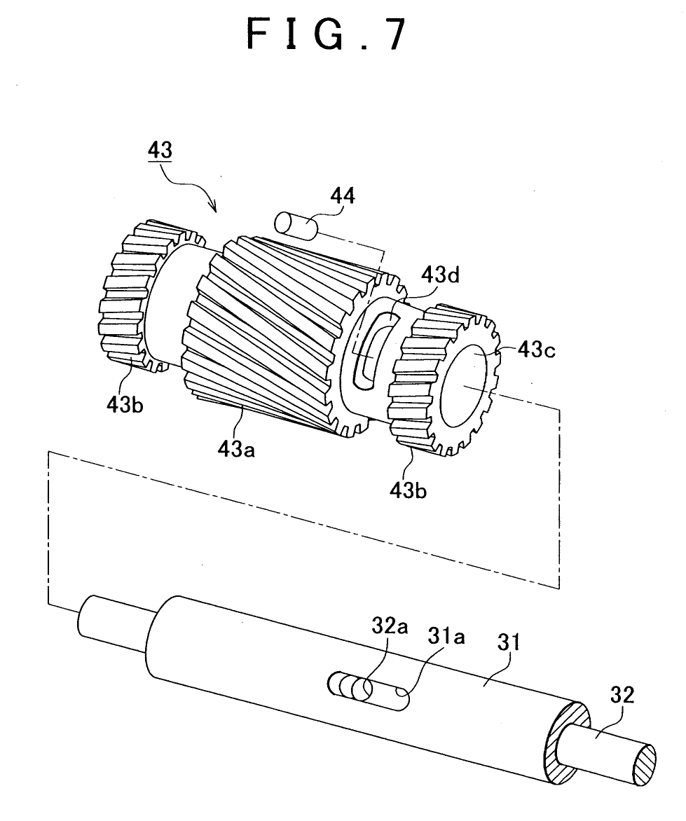

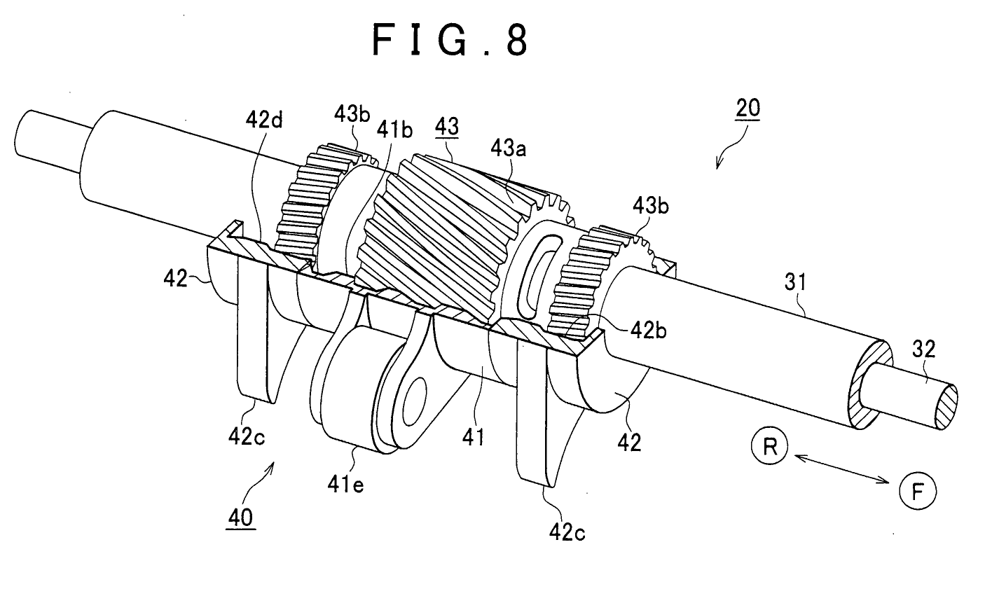

In the following description and the accompanying drawings, the present invention will be described in more detail with reference to example embodiments. FIG. 1 to FIGS. 14A and 14B show an embodiment of the invention.

FIG. 1 shows the schematic configuration of an internal combustion engine (hereinafter, simply referred to as “engine”) provided in a vehicle such as an automobile. In this embodiment, the engine 1 is a multi-cylinder gasoline engine such as a four-cylinder engine or a six-cylinder engine. However, for convenience of explanation, only one cylinder of the engine 1 is shown in FIG. 1.

In the engine 1 shown in FIG. 1, air is introduced into the combustion chamber 2a of a cylinder head 2 through an intake passage 3, and fuel is injected into the intake port 2b of the cylinder head 2 from a fuel injection valve 4. In the combustion chamber, air and fuel are mixed at a predetermined ratio to form air-fuel mixture. The air-fuel mixture in the combustion chamber 2a is ignited by an ignition plug 5 and burned. Then, exhaust gas generated by combustion is discharged from an exhaust port 2c through an exhaust passage 6.

The cylinder head 2 is provided with an intake valve 7 and an exhaust valve 8. The intake valve 7 opens and closes an intake port 2b. The exhaust valve 8 opens and closes an exhaust port 2c.

An electronically controlled throttle valve 9, an airflow meter 61, an intake-air temperature 62 (incorporated in an airflow meter 61) are provided in the upstream area of the intake passage 3. The electronically controlled throttle valve 9 adjusts the amount of air taken through an air cleaner (not shown). The airflow meter 61 outputs an electric signal corresponding to the amount of intake air. A throttle motor 9a drives the throttle valve 9. A throttle position sensor 63 detects the opening amount of the throttle valve 9.

Fuel is supplied under a predetermined pressure to the fuel injection valve 4 from a fuel tank by a fuel pump (neither of them are shown). The igniter 10 adjusts the ignition timing of the ignition plug 5. The engine 1 is provided with a coolant temperature sensor 64 that detects the temperature of engine coolant.

In the exhaust passage 6, a catalytic converter 11 and an oxygen sensor 65 are provided. The catalytic converter 11 reduces the amount of particulate matter and unburned gas in exhaust gas. The oxygen sensor 65 detects the concentration of oxygen in exhaust gas.

A piston 12 is connected to a crankshaft 14 via a connecting rod 13. The crankshaft 14 is connected to a transmission (not shown) via a flywheel damper 15.

A signal rotor 16 is fitted to the crankshaft 14. A crank position sensor 66 is provided near the signal rotor 16, i.e., on the side of the signal rotor 16. The crank position sensor 66 may be, for example, an electromagnetic pickup sensor. When the crankshaft 14 rotates, the crank position sensor 66 generates pulsed signals (output pulses) corresponding to a plurality of protrusions (teeth) 16a provided on the outer surface of the signal rotor 16.

The rotation of the crankshaft 14 is transmitted to an intake camshaft 17 and an exhaust camshaft 18. The intake valve 7 and the exhaust valve 8 are opened and closed by rotating the intake camshaft 17 and the exhaust camshaft 18, respectively. A cam position sensor 67 for cylinder discrimination is provided near the intake camshaft 17.

The cam position sensor 67 may be, for example, an electromagnetic pickup sensor. Although not shown in the drawings, the cam position sensor 67 is disposed to face one protrusion (tooth) on the outer surface of the rotor that is provided integrally with the intake camshaft 17. When the intake camshaft 17 rotates, the cam position sensor 67 outputs a pulsed signal. The intake camshaft 17 rotates at half the speed of the crankshaft 14. Therefore, each time the crankshaft 14 rotates by 720 degrees, the cam position sensor 67 generates one pulsed signal (output pulse).

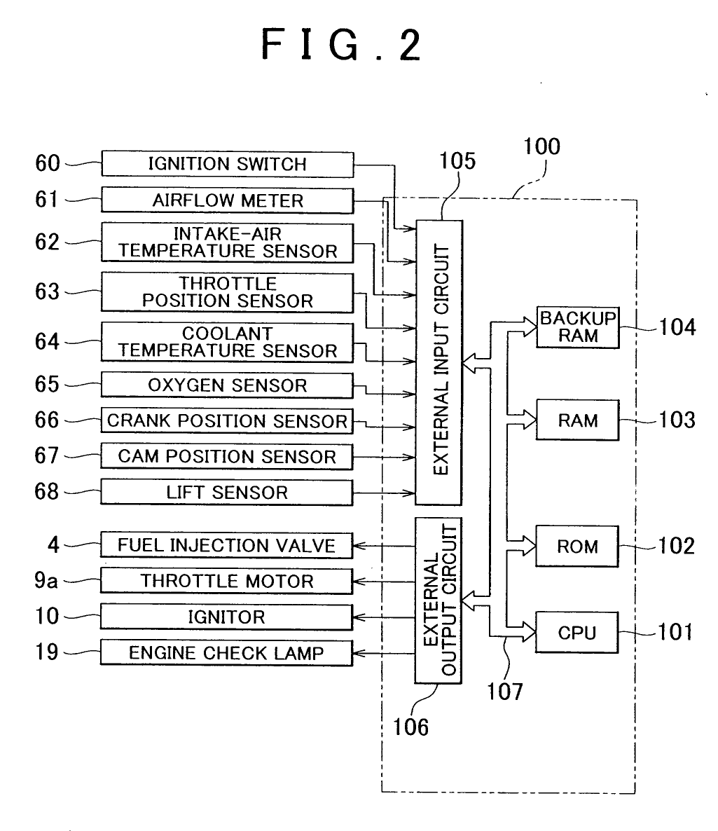

A control apparatus 100 controls the operating state of the engine 1. As shown in FIG. 2, the control apparatus 100 includes a commonly-known ECU (electronic control unit). The ECU includes a CPU 101, ROM 102, RAM 103, a backup RAM 104, an external input circuit 105, and an external output circuit 106 that are connected to each other by bi-directional bus 107.

The CPU 101 executes computations based on control programs and maps stored in the ROM 102.

Programs stored in the ROM 102 are used to execute at least a valve timing control, an air-fuel ratio control, and a misfire control. In the valve timing control operation of each intake valve 7 is controlled. In the air-fuel ratio control, the air-fuel ratio in the combustion chamber 2a is controlled. In the misfire control, it is determined whether a misfire occurs in the combustion chamber 2a, actions are taken if it is determined that the misfire occurs.

The results of computations executed by the CPU 101 and data input from each sensor are temporarily stored in the RAM 103. The backup RAM 104 is nonvolatile memory where data is saved.

The external input circuit 105 is connected to an ignition switch 60, the airflow meter 61, the intake-air temperature sensor 62, the throttle position sensor 63, the coolant temperature sensor 64, the oxygen sensor 65, the crank position sensor 66, the cam position sensor 67, a lift sensor 68, and the like.

The external output circuit 106 is connected to the fuel injection valve 4, the igniter 10 for the ignition plug 5, the throttle motor 9a of the throttle valve 9, an engine check lamp 19 that gives warning about a misfire, and the like.

The feature of the embodiment is the misfire control. Before describing the misfire control, components that are controlled by the misfire control will be described.

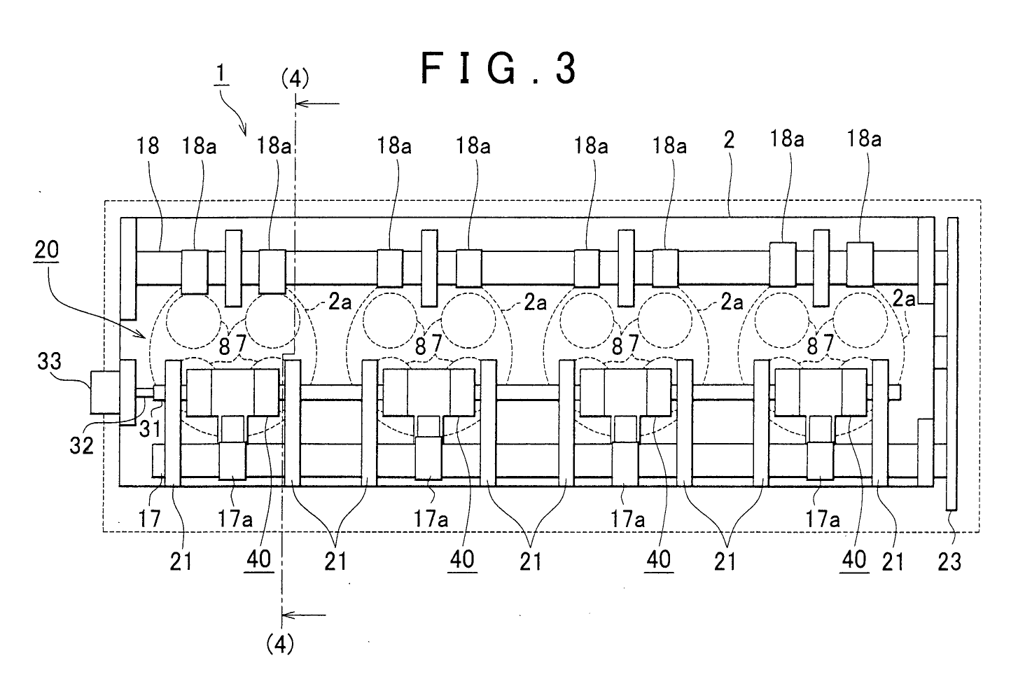

The aforementioned engine 1 further includes a variable valve mechanism 20 that changes the operational characteristic of the intake valve 7. The configuration of the variable valve mechanism 20 will be described with reference to FIG. 3 to FIG. 10A and FIG. 10B.

The exhaust valve 8 may be also driven by the variable valve mechanism 20. However, because the operation of the exhaust valve 8 is not directly related to the feature of the invention, description thereof will be omitted. Hereinafter, the case where the variable valve mechanism 20 is employed in an in-line four-cylinder DOHC engine will be described, as shown in FIG. 3.

The variable valve mechanism 20 continuously changes the valve lift and the duration of the intake valve 7. The variable valve mechanism 20 is provided between the intake cam 17a of the intake camshaft 17 and a roller rocker arm 24. One end of the roller rocker arm 24 is supported by a lash adjuster 25, and the other end of the rocker arm 24 contacts a tappet 7a at the upper end of the intake valve 7.

The variable valve mechanism 20 includes a rocker shaft 31, a control shaft 32, an actuator 33, and a valve lift mechanism 40.

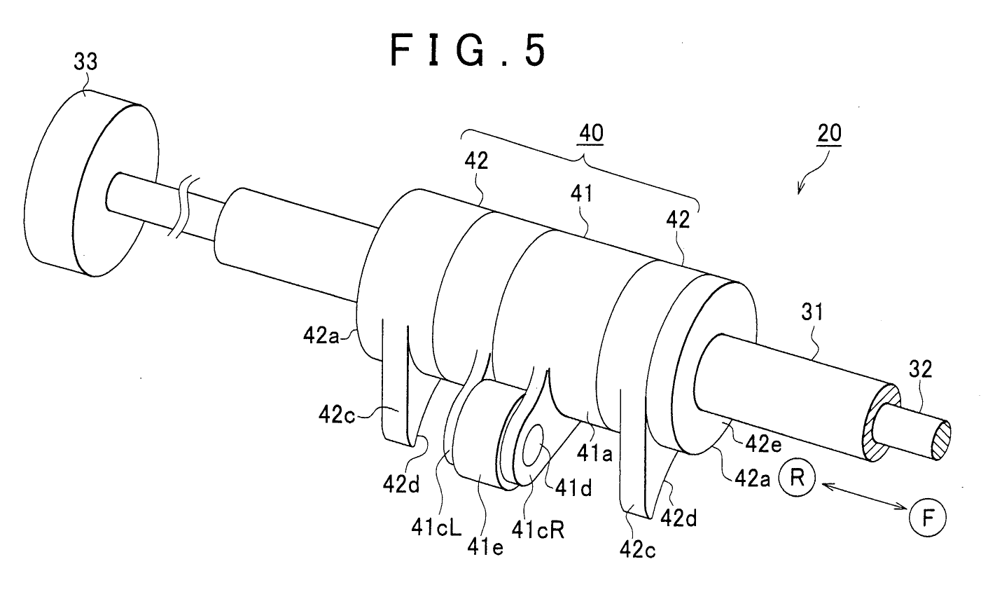

The rocker shaft 31 is fitted to a plurality of walls 21 provided at predetermined intervals in the cylinder head 2 such that the rocker shaft 31 does not move in the axial direction and in the circumferential direction. The rocker shaft 31 is disposed in parallel with the intake camshaft 17, that is, in the direction in which the cylinders are arranged (i.e., the direction shown by an arrow F-R in FIG. 5).

The control shaft 32 is inserted in the rocker shaft 31 such that the control shaft 32 can move in the axial direction. The actuator 33 moves the control shaft 31 in the axial direction.

The number of the valve lift mechanisms 40 is the same as the number of the cylinders. The valve lift mechanisms 40 are provided around the rocker shaft 31 such that the valve lift mechanisms 40 correspond to the respective cylinders. Each valve lift mechanism 40 includes an input arm 41, output arms 42, and a slider gear 43.

The input arm 41 includes a cylindrical housing 41a. A helical spline 41b that engages with an input-side helical spline 43a of the slider gear 43 is formed on the inner surface of the cylindrical housing 41a. A pair of forks 41cL and 41cR that protrudes outwardly in the radial direction is provided on the outer surface of the housing 41a. A roller 41e is rotatably supported between the forks 41cL and 41cR using a support shaft 41d that is disposed in parallel with the rocker shaft 31.

The output arm 42 includes a cylindrical housing 42a. A helical spline 42b that engages with an output-side helical spline 43b of the slider gear 43 is formed on the inner surface of the housing 42a. A nose 42c that protrudes outwardly in the radial direction is provided on the outer surface of the housing 42a. The nose 42c has a substantially triangle shape in the lateral view. One side of the triangle shape is a cam surface 42d. The cam surface 42d is a concave surface.

The slider gear 43 is provided around the rocker shaft 31 such that the slider gear 43 can move in the axial direction in conjunction with the control shaft 32. The input arm 41 and the two output arms 42 are provided around the slider gear 43. The slider gear 43 has a cylindrical shape. A through-hole 43c is formed at the center of the slider gear 43. The input-side helical spline 43a that engages with the helical spline 41b of the input arm 41 is formed on the outer surface of the slider gear 43 at an intermediate position in the axial direction. The output-side helical spline 43b that engages with the helical spline 42b of the output arm 42 is formed on the outer surface of the slider gear 43 at each end in the axial direction. The external diameter of the output-side helical spline 43b is smaller than that of the input-side helical spline 43a. The direction of the tooth trace of the input-side helical spline 43a is opposite to that of the output-side helical spline 43b.

The roller 41e of the input arm 41 is constantly pressed against the intake cam 17a by a spring 26 that is a so-called lost-motion spring. The spring 26 in the compressed state is provided in the cylinder head 2. The roller 24a of the roller rocker arm 24 is pressed against the base circle portion of the housing 42a of the output arm 42 or the cam surface 42d of the nose 42c by a valve spring 7b of the intake valve 7. As such, when the intake cam 17a rotates, the input arm 41 pivots, and the output arm 42 pivots integrally with the input arm 41. Accordingly, the intake valve 7 is lifted by the output arm 42 via the roller rocker arm 24.

The connection of the slider gear 43 with the rocker shaft 31 and the control shaft 32 will be described.

In the slider gear 43, a long hole 43d is formed between the input-side helical spline 43a and one of the output-side helical splines 43b. The long hole 43d extends in the circumferential direction, and extends from the outer surface to the inner surface of the slider gear 43 in the radial direction. A long hole 31a is formed in the rocker shaft 31 at a position corresponding to the long hole 43d of the slider gear 43. The long hole 31a extends in the axial direction, and extends from the outer surface to the inner surface of the rocker shaft 31. A through-hole 32a is formed in the control shaft 32 at a position corresponding to the long hole 31a of the rocker shaft 31.

The rocker shaft 31 is inserted in the through-hole 43c of the slider gear 43. A holding pin 44 is inserted in a position where the long hole 43d of the slider gear 43 intersects with the long hole 31a of the rocker shaft 31. One end of the holding pin 44 is fixed at the through-hole 32a of the control shaft 32 inserted in the rocker shaft 31.

The slider gear 43 thus assembled operates in the following manner.

(a) The holding pin 44 can move along the long hole 31a of the rocker shaft 31. Therefore, when the control shaft 32 moves in the axial direction, the slider gear 43 moves in the axial direction in conjunction with the control shaft 32.

(b) Because the holding pin 44 is inserted in the long hole 43d of the slider gear 43, when torque of the intake camshaft 17 is transmitted to the input arm 41, the slider gear 43 pivots around the rocker shaft 31.

Thus, though the position of the slider gear 43 on the control shaft 32 in the axial direction is fixed, the slider gear 43 can move on the rocker shaft 31 in the axial direction. The slider gear 43 can oscillate around the rocker shaft 31 (control shaft 32).

In the valve lift mechanism 40, when the slider gear 43 moves in the axial direction along with the control shaft 32 to change the position of the slider gear 43 with respect to the positions of the input arm 41 and the output arm 42, torsional force is applied to the input arm 41 and the output arm 42. The direction of the torsional force applied to the input arm 41 is opposed to the direction of the torsional force applied to the output arm 42. Accordingly, the input arm 41 and the output arm 42 rotate with respect to each other, and the difference in the phase between the input arm 41 (roller 41e) and the output arm 42 (nose 42c) is changed.

In the variable valve mechanism 20, the slider gears 43 for the respective cylinders are fixed to one control shaft 32. Therefore, when the control shaft 32 moves in the axial direction, the lift amounts of the intake valves 7 of all the cylinders are changed simultaneously.

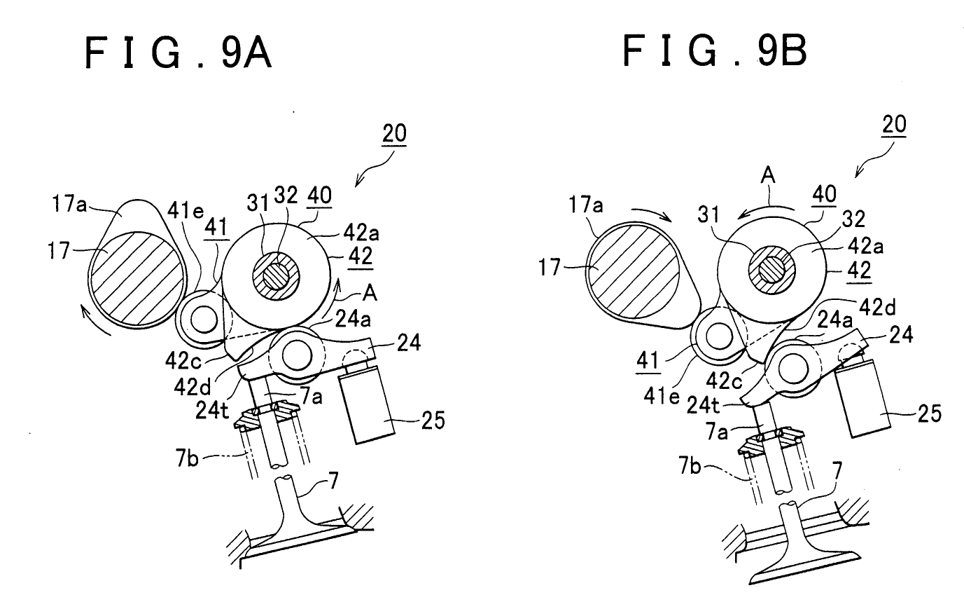

Next, operation of the variable valve mechanism 20 will be described. As shown in FIG. 9A, when the base circle portion of the intake cam 17a contacts the roller 41e of the input arm 41, the roller 24a of the roller rocker arm 24 contacts the base circle portion of the housing 42a of the output arm 42. Accordingly, the lift amount of the intake valve 7 is maintained at “0” (i.e., the intake port 2b of the engine 1 is kept closed).

When the intake camshaft 17 rotates in a clockwise direction, and the protruding portion of the intake cam 17a pushes the roller 41e of the input arm 41 downward, the input arm 41 pivots with respect to the rocker shaft 31 in a counterclockwise direction (i.e., the direction shown by an arrow A in FIG. 9A). Accordingly, the output arm 42 and the slider gear 43 integrally pivot.

As a result, the cam surface 42d formed in the nose 42c of the output arm 42 contacts the roller 24a of the roller rocker arm 24, and pushes the roller 24a downward.

As shown in FIG. 9B, when the cam surface 42d pushes the roller 24a of the roller rocker arm 24 downward, the roller rocker arm 24 pivots around a portion that contacts the lash adjuster 25, which opens the intake valve 7.

When the control shaft 32 is farthest from the actuator 33 (i.e., the control shaft 32 moves to the fullest extent in the direction shown by the arrow F in FIG. 5), the difference in the phase around the axis of the rocker shaft 31 between the roller 41e of the input arm 41 and the nose 42c of the output arm 42 is greatest.

Thus, the roller 24a of the roller rocker arm 24 rotates by the greatest amount when the intake cam 17a pushes the roller 41e downward to the fullest extent. As a result, the valve lift amount is greatest and the duration of the intake valve 7a is longest.

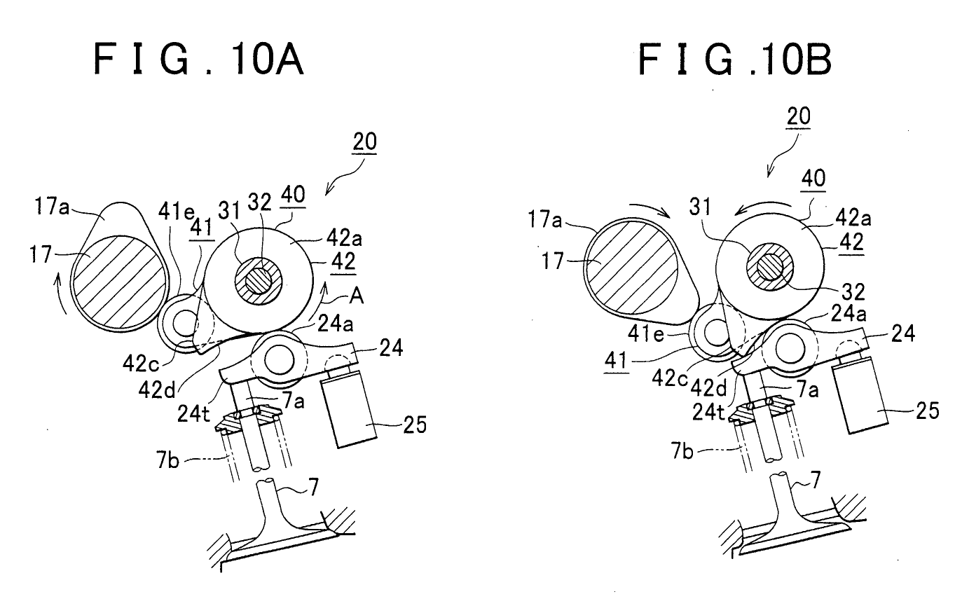

As shown in FIG. 10A, when the base circle portion of the intake cam 17a contacts the roller 41e of the input arm 41, the position where the output arm 42 contacts the roller 24a is farthest from the cam surface 42d. When the intake camshaft 17 rotates, and the protruding portion of the intake cam 17a pushes the roller 41e of the input arm 41 downward, the input arm 41 and the output arm 42 integrally pivot.

However, in this case, because the position where the output arm 42 contacts the roller 24a is farthest from the cam surface 42d, the output arm 42 rotates by a great amount until the cam surface 42d starts to push the roller 24a of the roller rocker arm 24 downward, as compared to the operating states shown in FIG. 9A and FIG. 9B. Also, when the protruding portion of the intake cam 17a pushes the roller 41e of the input arm 41 downward, the range of the cam surface 42d that contacts the roller 24a is reduced to a portion at the base-end side of the nose 42c. Therefore, the roller rocker arm 24 pivots by a small amount when the protruding portion of the intake cam 17a pushes the roller 41e downward.

As shown in FIG. 10B, because the roller rocker arm 24 pivots by a small amount, the lift amount of the intake valve 7 is smaller than that in the operating state shown in FIG. 9B.

When the control shaft 32 is nearest to the actuator 33 (i.e., the control shaft 32 moves to the fullest extent in the direction shown by the arrow R in FIG. 5), the difference in the phase around the axis of the rocker shaft 31 between the roller 41e and the nose 42c is smallest.

Thus, the roller 24a of the roller rocker arm 24 is rotated by the smallest amount when the intake cam 17a pushes the roller 41e downward to the fullest extent. As a result, the valve lift amount and the duration of the intake valve 7a is smallest.

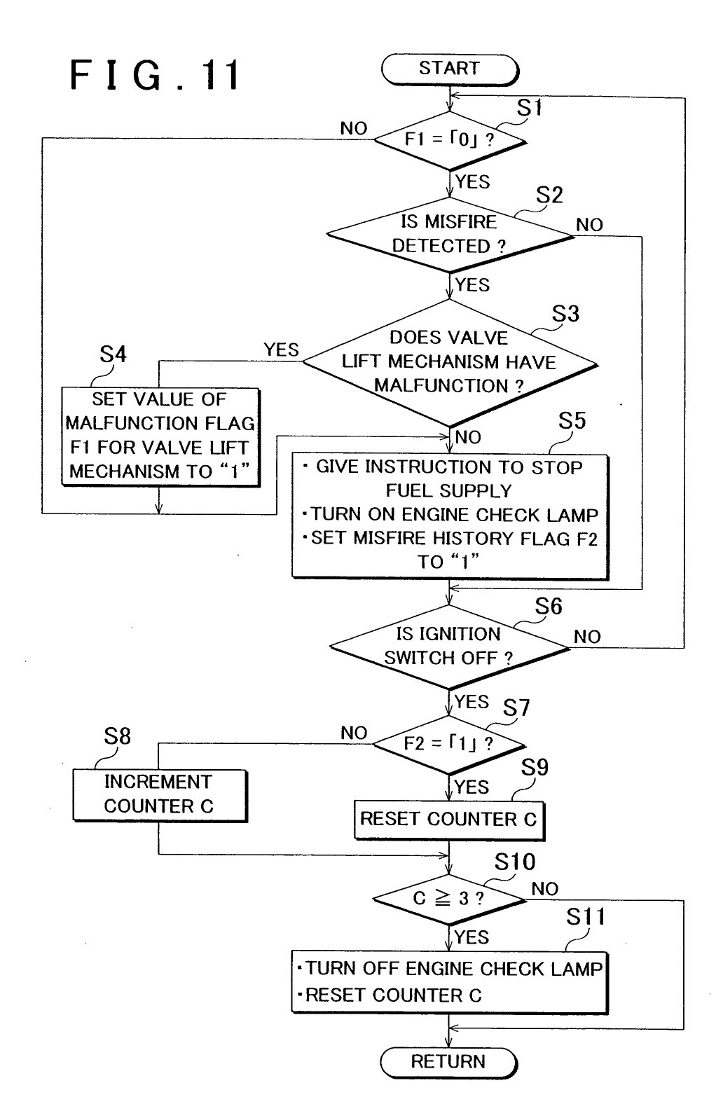

Hereinafter, the misfire control that is executed by the control apparatus 100 according to the invention will be described with reference to FIG. 11 to FIGS. 14A and 14B.

Basically, the control apparatus 100 controls the engine 1 as follows. After the engine 1 is started by the ignition switch 60, fuel is injected into the combustion chamber 2a from the fuel injection valve 4 so that the fuel-air mixture ratio is equal to a predetermined value at the time of engine start. Also, the fuel is ignited by the ignition plug 5 via the igniter 10 to start explosion and combustion. Then, after the start of the engine 1 is detected using the crank position sensor 66 and the like, the fuel injection amount and the injection timing of the fuel injection valve 4 are determined based on the data output from the accelerator position sensor (not shown) and the crank position sensor 66. The fuel injection valve 4 is controlled in accordance with the determined fuel injection amount and the injection timing. Based on the output from each sensor, the duration, the lift amount, and the like of the intake valve 7 are controlled by the variable valve mechanism 20. Thus, the intake valve 7 is operated in accordance with the operational characteristic appropriate for the operating state.

After the engine 1 is started as described above, a misfire may occur during a combustion stroke.

A misfire may occur due to a temporary condition, such as clogging of the fuel injection valve 4, smoldering of the ignition plug 5, or failure in compression of air-fuel mixture in the combustion chamber 2a. A misfire may also occur due to a problem that is difficult to solve, such as the malfunction of the valve lift mechanism 40 in the variable valve mechanism 20.

The malfunction of the valve lift mechanism 40 may be, for example, the phenomenon in which the input arm 41 is not oscillated by the intake cam 17a due to breakage of the forks 41cR and 41cL. However, it is to be noted that the valve lift mechanism 40 is generally designed such that sufficient strength and sufficient load bearing are ensured at each component of the valve lift mechanism 40.

According to the invention, the misfire control is executed to take effective actions to eliminate the misfire caused by the aforementioned problems. Hereinafter, the actions will be described.

When a misfire occurs due to the aforementioned temporary condition, supply of fuel is stopped for a short period. That is, fuel injection into a cylinder in which the misfire occurs is stopped from a next intake stroke until the misfire is corrected.

When a misfire occurs due to the aforementioned problem that is difficult to solve, supply of fuel is stopped for a long period. That is, fuel injection into a cylinder in which the misfire occurs is continuously stopped from the next intake stroke until the malfunction of the valve lift mechanism 40 is corrected, regardless of whether the engine 1 stops.

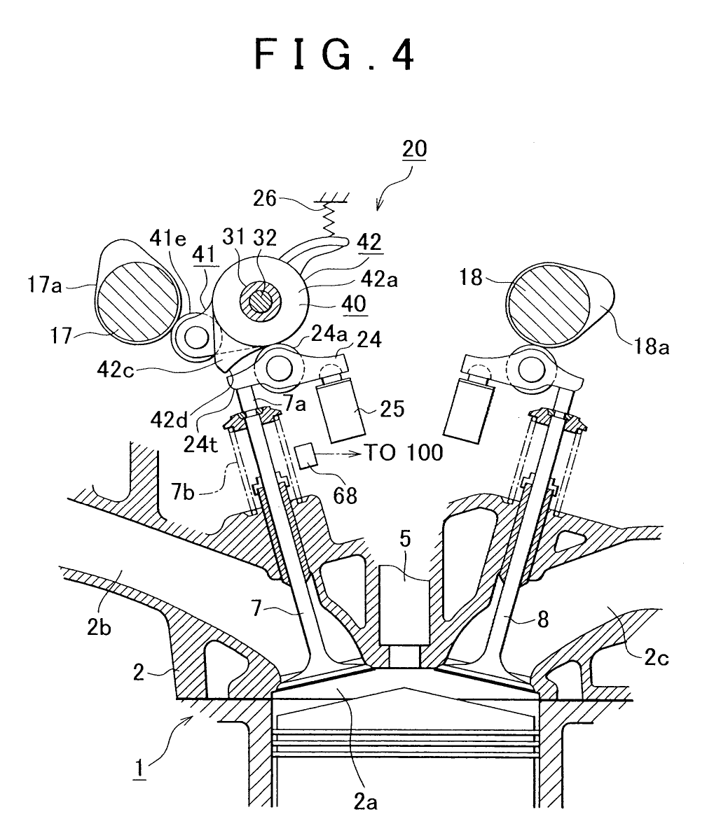

More specifically, in the case where the lift sensor 68 is provided to detect the lift amount of the intake valve 7 as shown in FIG. 4, the lift sensor 68 can directly detect the malfunction of the valve lift mechanism 40.

The misfire control routine executed in the case where the lift sensor 68 is provided will be described with reference to FIG. 11. The misfire control routine starts each time the combustion stroke of the engine 1 starts.

In step S1, it is determined whether the value of a malfunction flag F1 for the valve lift mechanism 40 is “0”. In this step, by checking a diagnosis history of the backup RAM 104, it is determined whether the valve lift mechanism 40 has a malfunction at present.

The value “1” of the malfunction flag F1 in the diagnosis history indicates that the malfunction occurred and supply of fuel was cut in the past. The value “0” of the malfunction flag F1 indicates that the valve lift mechanism 40 has been replaced or repaired. The diagnosis history is reset by the external operation.

If the value of the malfunction flag F1 is “0”, that is, if the valve lift mechanism 40 does not have the malfunction at present, or if the valve lift mechanism 40 has already been replaced or repaired though the malfunction occurred in the past, an affirmative determination is made in step S1, and the routine proceeds to step S2.

If the value of the malfunction flag F1 is “1”, a negative determination is made in step S1, and the routine proceeds to step S5.

In step S2, it is determined whether a misfire occurs in each cylinder by determining whether at least one of i) a condition the amount by which the rotational speed NE of the engine 1 changes is greater than or equal to a predetermined threshold value, ii) a condition that the temperature of exhaust gas is lower than or equal to a predetermined threshold value, and iii) a condition that the magnitude of pulsation of intake air is less than or equal to a predetermined threshold value is satisfied.

For example, based on the outputs from the crank position sensor 66 and the cam position sensor 67, required times T1, T2, T3, and T4 are sequentially calculated. The required times T1, T2, T3, and T4 are the times required for the crankshaft 14 to rotate by a certain crank angle during the combustion stroke of a first cylinder, a second cylinder, a third cylinder, and a fourth cylinder, respectively. Then, change amounts ANE1 to ANE4 in the first to fourth cylinders (i.e., the amounts by which the required times T1, T2, T3, and T4 change) are sequentially calculated.

When at least one of the change amounts ANE1 to ANE4 in the first to fourth cylinders exceeds a predetermined threshold value, it is determined that the misfire occurs. If it is determined that the misfire occurs, the cylinder in which the misfire occurs is identified based on the outputs from the crank position sensor 66 and the cam position sensor 67, and the calculated change amounts ANE1 to ANE4.

If no misfire occurs, a negative determination is made in step S2, and the routine proceeds to step S6. If the misfire occurs, an affirmative determination is made in step S2, and the cause of the misfire is determined and actions are taken according to the determined cause in step S3 to S5.

That is, in step S3, it is determined whether the misfire occurs due the malfunction of the valve lift mechanism 40, based on the output from the lift sensor 68.

When the output from the lift sensor 68 is “0” or lower than or equal to a predetermined threshold value, it can be determined that a problem that is difficult to solve occurs, for example, the input arm 41 is not oscillated by the intake cam 17a due to breakage of the forks 41cR and 41cL of the valve lift mechanism 40. In this case, an affirmative determination is made in step S3, the value of the malfunction flag F1 for the valve lift mechanism 40 is set to “1” in step S4, and the routine proceeds to step S5.

If the valve lift mechanism 40 normally operates, that is, if the misfire occurs due to the temporary condition, such as clogging of the fuel injection valve 4, smoldering of the ignition plug 5, or failure in compression of air-fuel mixture in the combustion chamber 2a, a negative determination is made in step S3, and the routine proceeds to step S5.

In step S5, an instruction is given to stop supply of fuel to the cylinder identified in step S2 during the next intake stroke. That is, the instruction is given to stop the operation of the fuel injection valve 4 corresponding to the cylinder in which the misfire occurs to stop fuel injection to the cylinder from the fuel injection valve 4. Also, the engine check lamp 19 is turned on, and the value of a misfire history flag 2 is set to “1”.

In step S6, it is determined whether the ignition switch 60 is off. If the ignition switch 60 is not off, a negative determination is made. Then, the routine returns to step S1 and the aforementioned control is repeated. If the ignition switch 60 is off, an affirmative determination is made. Then, it is determined whether the misfire is corrected and actions are taken according to the situation.

In step S7, it is determined whether the value of the misfire history flag F2 is “1” to determine whether at least one misfire occurred in previous trips.

If the value of the misfire history flag F2 is “0”, a negative determination is made in step S7, and the value of a counter C is incremented in step S8. The counter C shows the accumulated number of the trips in which no misfire occurs. If the value of the misfire history flag F2 is “1”, an affirmative determination is made in step S7, and the value of the counter C is reset to “0” in step S9.

Then, in step S10, it is determined whether the value of the counter C is greater than or equal to a predetermined value (for example, three) to determine whether no misfire occurred in a predetermined number of consecutive trips (for example, three consecutive trips).

If an affirmative determination is made in step S10, it is determined that the misfire is corrected. Then, the engine check lamp 19 is turned off, and the value of the counter C is reset to “0” in step S11, and the routine is terminated. If a negative determination is made in step S10, step S11 is skipped, and the routine is terminated.

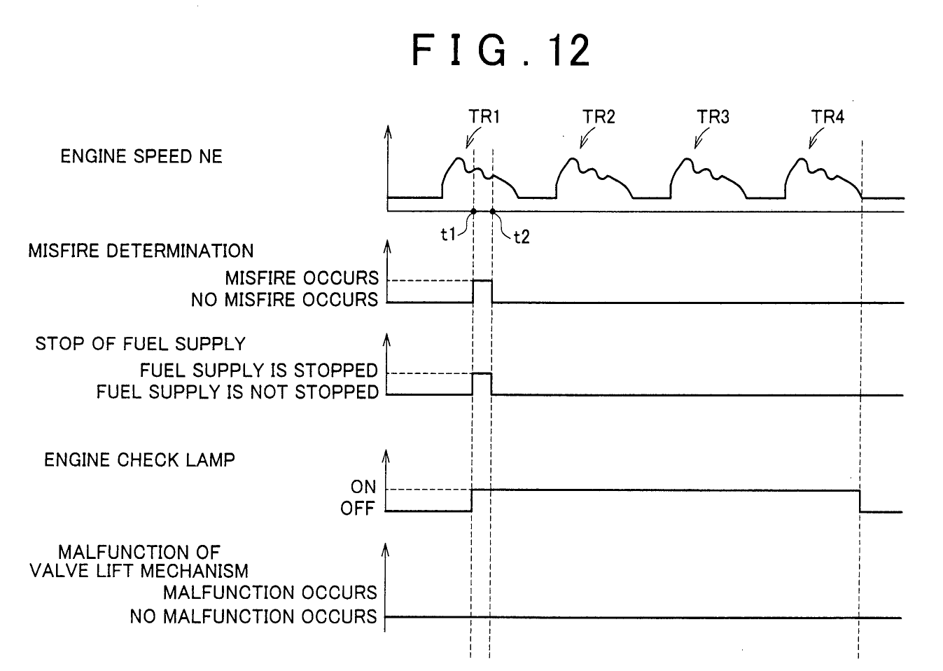

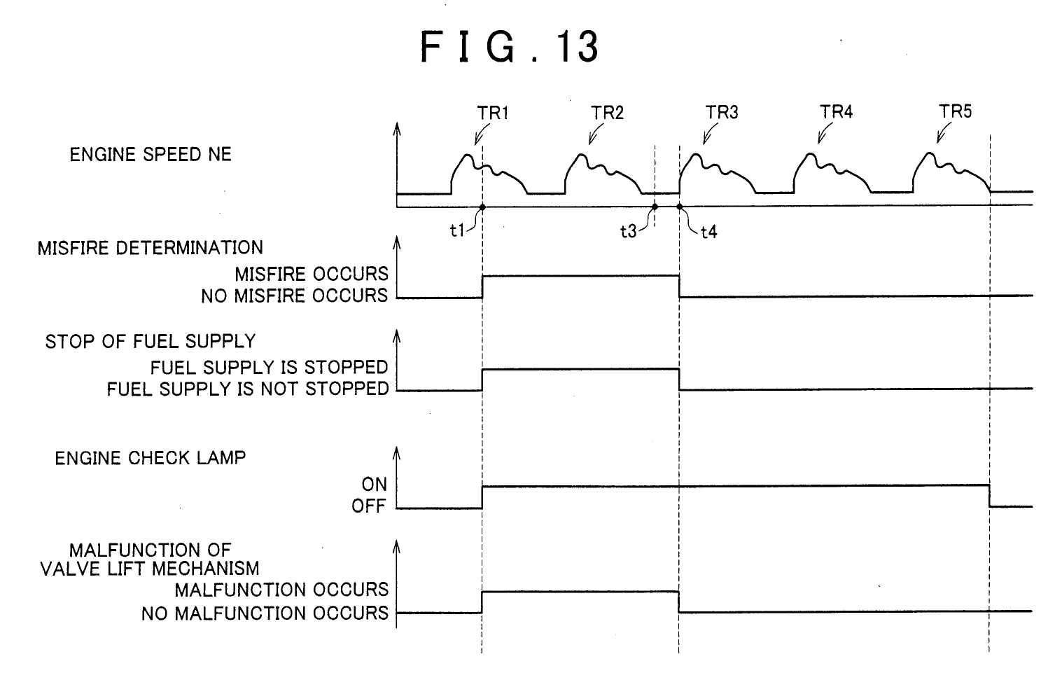

The misfire control executed in each case where a misfire occurs due to a different problem will be described with reference to, for example, the timing charts shown in FIG. 12 and FIG. 13.

In a first case, a temporary misfire occurs due to the aforementioned temporary condition. In the timing chart shown in FIG. 12, a misfire occurs at time point t1 in a first trip TR1 as shown in the top graph, the misfire is detected as shown in the second graph from the top, fuel supply is stopped as shown in the third graph from the top, and the engine check lamp 19 is turned on as shown in the second graph from the bottom.

If the malfunction of the valve lift mechanism 40 is not detected as shown in the bottom graph, and the misfire is corrected at time point t2 in the first trip TR1 in the top graph after a predetermined time elapses, it is determined that no misfire occurs as shown in the second graph from the top, and fuel supply is restarted.

However, the engine check lamp 19 remains on. After the first trip TR1 ends, if no misfire is detected in each of the second trip TR2 to the fourth trip TR4, the engine check lamp 19 is turned off.

In second case, a misfire occurs due to the aforementioned malfunction of the valve lift mechanism 40. In the timing chart shown in FIG. 13, a misfire occurs at time point t1 in the first trip TR1 as shown in the top graph, the misfire is detected as shown in the second graph from the top, fuel supply is stopped as shown in the third graph, and the engine check lamp 19 is turned on as shown in the second graph from the bottom.

If the malfunction of the valve lift mechanism 40 is detected at time point t1 in the first trip TR1 as shown in the bottom graph, fuel supply continues to be stopped until the valve lift mechanism 40 is replaced or repaired, as shown in the third graph from the top.

In the case where the valve lift mechanism 40 is replaced or repaired at time point t3 as shown in the top graph, if no misfire occurs at time point t4 in the third trip TR3 in the top graph, that is, if it is determined that no misfire occurs as shown in the second graph, fuel supply is restarted as shown in the third graph.

However, the engine check lamp 19 remains on. After the second trip TR2 ends, if no misfire is detected in each of the third trip TR3 to the fifth trip TR5, the engine check lamp 19 is turned off.

As described above, according to the embodiment, if a misfire occurs because the intake valve 7 is kept closed and is unable to open due to the malfunction of the valve lift mechanism 40 in the variable valve mechanism 20, fuel supply continues to be stopped until the misfire is corrected by replacing or repairing the valve lift mechanism 40. Accordingly, while the valve lift mechanism 40 has the malfunction, fuel is not injected. Therefore, it is possible to prevent occurrence of a secondary problem, such as the accumulation of fuel in the intake port 2b.

If a temporary misfire occurs due to the problem other than the malfunction of the valve lift mechanism 40, that is, the temporary condition, fuel supply is stopped until the misfire is corrected. Thus, while the misfire occurs, fuel injection is stopped to increase the temperature of the combustion chamber 2a. Accordingly, the misfire can be corrected early. Further, the normal fuel injection control is restarted after the misfire is corrected. Therefore, the engine 1 normally operates after the misfire is corrected.

Further, when the misfire occurs, the user of the vehicle or a person who performs inspection and maintenance is notified of the misfire by the turning on of the engine check lamp 19. Therefore, for example, inspection and maintenance of the engine 1 can be performed soon after the misfire is identified. This is advantageous in maintaining the engine 1 in the normal state.

In the case where the malfunction of the valve lift mechanism 40 is directly detected using the lift sensor 68 as described above, the cause of the misfire can be determined, and the actions can be taken based on the determined cause.

However, in the case where the lift sensor 68 is not provided, the malfunction of the valve lift mechanism 40 cannot be directly detected. Therefore, the malfunction control is executed as follows.

If a misfire is detected, fuel supply continues to be stopped until the current trip ends, and fuel supply is restarted to restart the normal fuel injection control at the start of the next trip. However, if a misfire occurs in each of a predetermined number of consecutive trips (for example, three consecutive trips), restart of fuel supply and restart of the normal fuel injection control are prohibited.

With this configuration, on the assumption that a misfire may occur due to the temporary condition, the normal fuel injection control is restarted in the next trip, regardless of whether the problem is solved. Therefore, if the problem is solved in the next trip, the combustion is normally performed in the engine 1. Further, on the assumption that a misfire may occur due to the problem that is difficult to solve, restart of the normal fuel injection control is prohibited if misfires occur for a predetermined time or longer. Therefore, it is possible to prevent occurrence of a secondary problem, such as a problem that a great amount of fuel accumulates in the intake port 2b.

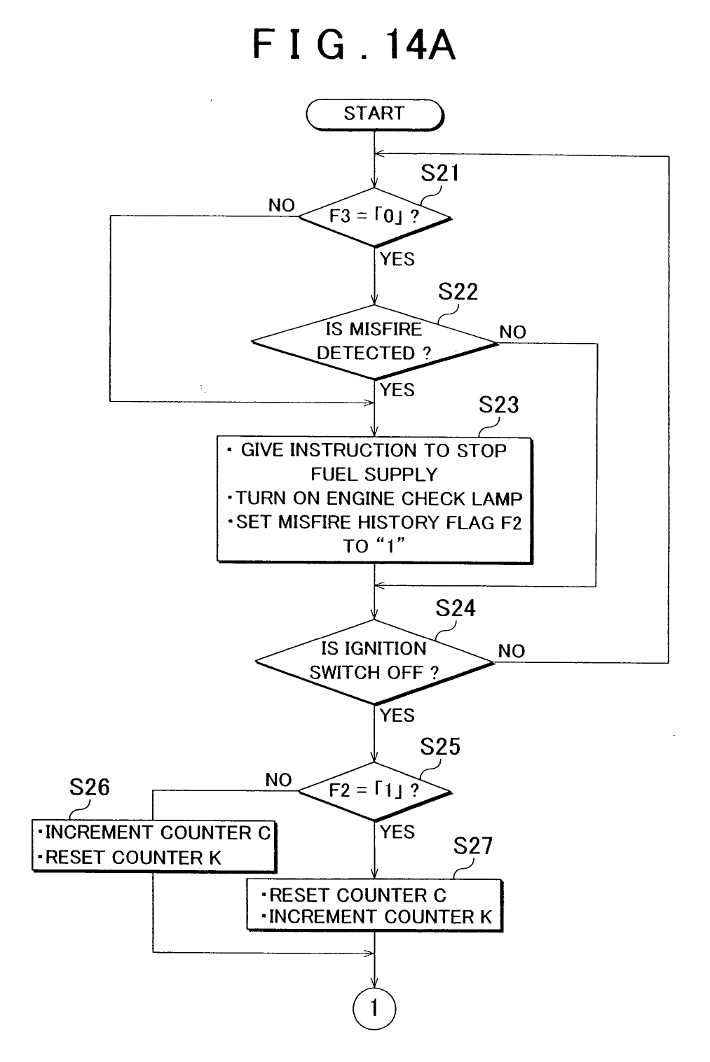

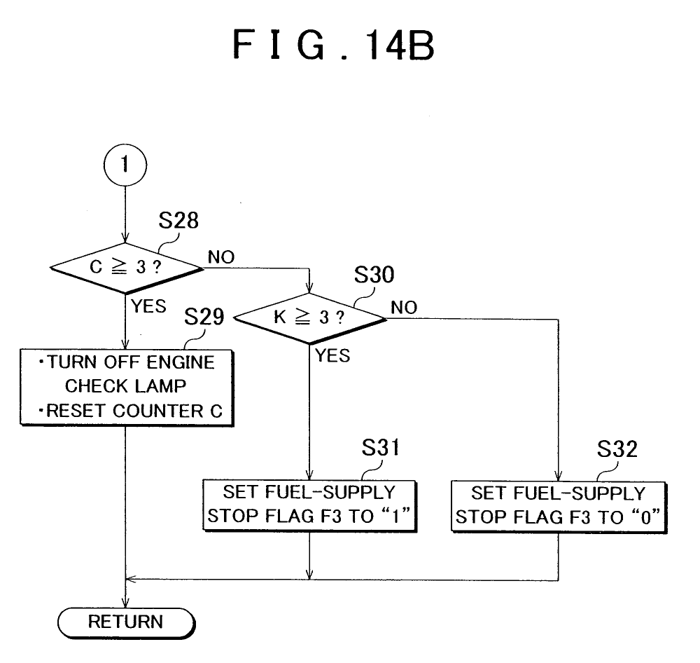

The misfire control will be described in more detail with reference to the flowchart shown in FIGS. 14A and 14B. In step S21, it is determined whether the value of a fuel-supply stop flag F3 is “0” to determine whether fuel supply should continue to be stopped.

The value “1” of the fuel-supply stop flag F3 indicates that a misfire occurred due to the problem that is difficult to solve such as the malfunction of the valve lift mechanism 40 in the past. The value “0” of the fuel-supply stop flag F3 indicates that no misfire occurred or a misfire occurred due to the temporary condition in the past.

If the value of the fuel-supply stop flag F3 is “1”, a negative determination is made in step S21, and the routine proceeds to step S23.

If the value of the fuel-supply stop flag F3 is “0”, an affirmative determination is made in step S21, and the routine proceeds to step S22.

In step S22, it is determined whether a misfire occurs in each cylinder. Basically, the process of determining whether a misfire occurs in any cylinder is the same as that in step S2 in FIG. 11. Therefore, description of the process will be omitted.

If no misfire occurs, a negative determination is made in step S22, and the routine proceeds to step S24. If the misfire occurs, an affirmative determination is made in step S22, and the routine proceeds to step S23.

In step S23, the instruction is given to stop supply of fuel to the cylinder identified in step S22 during the next intake stroke. That is, the instruction is given to stop the operation of the fuel injection valve 4 corresponding to the cylinder in which the misfire occurs to stop fuel injection to the cylinder from the fuel injection valve 4. Also, the engine check lamp 19 is turned on, and the value of the misfire history flag 2 is set to “1”.

In step S24, it is determined whether the ignition switch 60 is off. If the ignition switch 60 is not off, a negative determination is made. Then, the routine returns to step S21 and the aforementioned control is repeated. If the ignition switch 60 is off, an affirmative determination is made. Then, it is determined whether the misfire is corrected, and actions are taken according to the situation in steps S25 to S32.

In step S25, it is determined whether the value of the misfire history flag F2 is “1” to determine whether at least one misfire occurred in previous trips.

If the value of the misfire history flag F2 is “0”, a negative determination is made in step S25. Then, the value of the counter C is incremented and the value of a counter K is reset to “0” in step S26. The counter K shows the accumulated number of the trips in which misfires occur.

If the value of the misfire history flag F2 is “1”, an affirmative determination is made in step S25. Then, the value of the counter C is reset to “0”, and the value of the counter K is incremented in step S27.

Then, in step S28, it is determined whether the value of the counter C is greater than or equal to a predetermined value (for example, three) to determine whether no misfire occurred in a predetermined number of consecutive trips (for example, three consecutive trips).

If an affirmative determination is made in step S28, it is determined that the misfire is corrected. Then, the engine check lamp 19 is turned off, and the value of the counter C is reset to “0” in step S29, and the routine is terminated.

If a negative determination is made in step S28, it is determined whether the value of the counter K is greater than or equal to a predetermined value (for example, three) to determine whether a misfire occurred in each of a predetermined number of consecutive trips (for example, three consecutive trips) in step S30.

If an affirmative determination is made in step S30, it is determined that the misfire occurs due to the problem that is difficult to solve. Then, the value of the fuel-supply stop flag F3 is set to “1” in step S31, and the routine is terminated.

If a negative determination is made in step S30, it is determined that the misfire occurs due to the temporary condition. Then, the value of the fuel-supply stop flag F3 is set to “0” in step S32, and the routine is terminated.

As described above, even in the case where the lift sensor 68 is not provided, after a misfire is detected, the actions can be taken in both of the case where the misfire occurs due to the temporary condition and the case where the misfire occurs due to the problem that is difficult to solve.

Other embodiments of the invention will be described.

(1) In the aforementioned embodiment, the control apparatus 100 according to the invention is used in the port-injection engine 1 in which fuel is injected into the intake port 2b. However, the control apparatus 100 according to the invention may be used, for example, in the direct-injection engine in which fuel is directly injected into the combustion chamber 2a.

In the direct-injection engine, if a problem that is difficult to solve occurs, for example, if the intake valve 7 cannot be opened due to the malfunction of the valve lift mechanism 40, the supply of air into the combustion chamber 2a is interrupted, which results in a misfire. However, because supply of fuel to the combustion chamber 2a is also stopped, it is possible to prevent occurrence of a secondary problem, such as the discharge of unburned fuel to the exhaust port 2c from the combustion chamber 2a.

(2) In the aforementioned embodiment, the variable valve mechanism 20 is provided only for the intake valves 7. However, the control apparatus 100 according to the invention may be used in an engine in which the variable valve mechanism 20 is provided for the exhaust valves 8.

(3) In the aforementioned embodiment, the two intake valves 7 are provided for each cylinder in the engine 1. However, the number of the intake valves 7 is not limited to a specific number.

(4) In the aforementioned embodiment, the engine check lamp 19 is turned on when a misfire is detected. However, the invention is not limited to this configuration. For example, the warning may be provided by sounding a buzzer or the like, or by indicating character information in a meter panel.

While the invention has been described with reference to example embodiments thereof, it is to be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

1. A control apparatus for an internal combustion engine which includes a variable valve mechanism that changes an operational characteristic of an intake valve using a valve lift mechanism disposed between a cam and the intake valve, and a fuel injection valve that supplies fuel to each of a plurality of cylinders of the internal combustion engine individually, comprising:
a controller that determines whether a misfire occurs in any of the plurality of cylinders, wherein if the controller determines that a misfire occurs, the controller determines whether the intake valve is unable to open due to a malfunction of the valve lift mechanism; and if the controller determines that the intake valve is unable to open, the controller stops operation of the fuel injection valve corresponding to a cylinder of the plurality of cylinders, in which the misfire occurs, to stop a fuel supply to the cylinder from a next intake stroke until the malfunction of the valve lift mechanism is corrected, regardless of whether the internal combustion engine stops.

2. The control apparatus according to claim 1, wherein if it is determined that the intake valve is able to open, the controller stops operation of the fuel injection valve corresponding to the cylinder in which the misfire occurs to stop the fuel supply to the cylinder from the next intake stroke until the misfire is corrected.

3. The control apparatus according to claim 1, wherein the controller includes a notification device that provides notification when a misfire occurs and the fuel supply is stopped.

4. The control apparatus according to claim 1, wherein the controller determines that a misfire occurs when at least one of i) a condition that an amount of change in a rotational speed of the internal combustion engine is greater than or equal to a predetermined threshold value; ii) a condition that a temperature of exhaust gas is lower than or equal to a predetermined threshold value; and iii) a condition that a magnitude of pulsation of intake air is less than or equal to a predetermined threshold value, is satisfied.

5. The control apparatus according to claim 1, wherein the controller uses an output from a lift sensor that detects a lift amount of the intake valve.

6. A control apparatus for an internal combustion engine which includes a variable valve mechanism that changes an operational characteristic of an intake valve using a valve lift mechanism disposed between a cam and the intake valve, and a fuel injection valve that supplies fuel to each of a plurality of cylinders of the internal combustion engine individually, comprising
a controller that determines whether a misfire occurs in any of the plurality of cylinders, wherein if the controller determines that a misfire occurs, the controller stops operation of the fuel injection valve corresponding to a cylinder of the plurality of cylinders, in which the misfire occurs, to stop a fuel supply to the cylinder from a next intake stroke until the internal combustion engine stops.

7. The control apparatus according to claim 6, wherein if it is determined that a misfire occurs during each of a predetermined number of trips after a trip in which it is first determined a misfire occurs, the controller continues to stop the fuel supply, and prohibits restart of a normal fuel injection control.

8. A control method for an internal combustion engine which includes a variable valve mechanism that changes an operational characteristic of an intake valve using a valve lift mechanism disposed between a cam and the intake valve, and a fuel injection valve that supplies fuel to each of a plurality of cylinders of the internal combustion engine individually, comprising:
determining whether a misfire occurs in any of the plurality of cylinders;
determining whether the intake valve is unable to open due to a malfunction of the valve lift mechanism if it is determined that a misfire occurs; and
stopping operation of the fuel injection valve corresponding to a cylinder of the plurality of cylinders, in which the misfire occurs, to stop a fuel supply to the cylinder from a next intake stroke until the malfunction of the valve lift mechanism is corrected, regardless of whether the internal combustion engine stops, if it is determined that the intake valve is unable to open.

9. The control method according to claim 8, further comprising:
stopping operation of the fuel injection valve corresponding to the cylinder in which the misfire occurs to stop the fuel supply to the cylinder from the next intake stroke until the misfire is corrected, if it is determined that the intake valve is able to open.

10. The control method according to claim 8, further comprising:
providing notification when a misfire occurs and the fuel supply is stopped.

11. The control method according to claim 8, wherein it is determined that a misfire occurs when at least one of i) a condition that an amount of change in a rotational speed of the internal combustion engine is greater than or equal to a predetermined threshold value; ii) a condition that a temperature of exhaust gas is lower than or equal to a predetermined threshold value; and iii) a condition that a magnitude of pulsation of intake air is less than or equal to a predetermined threshold value, is satisfied.

12. The control method according to claim 8, wherein an output from a lift sensor that detects a lift amount of the intake valve is used to determine whether the intake valve is unable to open due to the malfunction of the valve lift mechanism if it is determined that a misfire occurs.

13. A control method for an internal combustion engine which includes a variable valve mechanism that changes an operational characteristic of an intake valve using a valve lift mechanism disposed between a cam and the intake valve, and a fuel injection valve that supplies fuel to each of a plurality of cylinders of the internal combustion engine individually, comprising:
determining whether a misfire occurs in any of the plurality of cylinders; and
stopping operation of the fuel injection valve corresponding to a cylinder of the plurality of cylinders, in which the misfire occurs, to stop a fuel supply to the cylinder from a next intake stroke until the internal combustion engine stops.

14. The control method according to claim 13, further comprising:
continuing to stop the fuel supply, and prohibiting restart of a normal fuel injection control if it is determined that a misfire occurs during each of a predetermined number of trips after a trip in which it is first determined a misfire occurs.
